(19) United States
(12) Patent Application Publication
(10) Pub. No.: US 2002/0077858 A1
(43) Pub. Date: Jun. 20, 2002

(54) System and method for providing a remedial video support group

(76) Inventor: John Haines, Lantana, FL (US)

Correspondence Address: Scott A. Horstemeyer, Thomas, Kayden, Horstemeyer & Risley, LLP, Suite 1750, 100 Galleria Parkway, Atlanta, GA, 30339, US

(21) Appl. No.: 09/738,343

(22) Filed: Dec. 15, 2000

(51) Int. Cl. G06F 17/60

(52) U.S. Cl. 705/3

(57) ABSTRACT

A system and method for providing a remedial video support group is disclosed. The system utilizes a patient terminal that provides voice, sound and data capabilities to medical patients. A caregiver, having a caregiver terminal, is provided with medical records and personal information regarding each individual within a group of patients having the same, or similar illness. The caregiver schedules a specific time for a live video conference that all selected patients are invited to attend via their terminals. The live video conference addresses the symptoms and progression of the illness shared by individuals within the group, and treatment of the illness, as well as mental anguish and personal experiences. The terminals are also used to ensure that the patient is performing proper treatment methods in addressing the illness in accordance with prescribed medical care.

### FIELD OF THE INVENTION

The present invention generally relates to computer networking and, more particularly, is related to a system and method for providing a video support group to medical patients to assist in the treatment of medical conditions.

### BACKGROUND OF THE INVENTION

The discovery of the onset of illness, especially terminal and chronic illness, typically leads to extreme mental anguish. Individuals that discover such illnesses, hereinafter referred to as “patients,” often have difficulty expressing their feelings to family members, friends, and others. Without having a means of venting concerns and fears attributed to the discovery of illness, stress and anguish gather in the patient, thereby adding additional health concerns to a patient that is already latent with illness.

Doctors initially provide a source of expressing concerns and fears encountered by the patient in the form of counseling, however, continual use of doctors as counselors is relatively expensive. In addition, doctor association with such illnesses is typically based exclusively on textual and practical knowledge, instead of personal experience.

To address the shortcomings of counseling provided by doctors, support groups have been established wherein a group leader, typically an individual having knowledge regarding the patient's illness, leads a group of individuals in a round table or classroom setting. Such individuals are typically either doctors, nurses, or individuals that have been inflicted with the same illness as the patient. Support groups are beneficial since they provide an atmosphere where a patient may discuss their illness with others inflicted with the same or similar illness, and with an individual having considerable knowledge of the illness.

Unfortunately, certain types of illnesses limit mobility of a patient such that physically attending support groups is not an option. With the advancement of technology, the Internet has provided a means of allowing individuals to communicate via a computer based system. Internet forums, or groups, allow individuals to gather in a virtual text-based forum wherein the expression of opinions and ideas may be provided. Typically, when a specific topic is addressed by the virtual forum, an expert in the field monitors the forum and answers questions provided by individuals partaking in the forum. Virtual forums have been conducted to address particular illnesses wherein individuals may partake in a discussion or ask an expert questions regarding a covered topic which may be answered by the expert or other individuals within the virtual forum.

Unfortunately, individuals that conduct and maintain Internet forums typically do not possess personal information about individuals partaking in forum discussion, including the patient's illness stage, symptoms, and family health history. These factors, among others, contribute to proper treatment and support of patients. Further, individuals attending Internet forums typically join due to personal interest and may not be personally seeking treatment. Therefore, the focus of forums tend to drift away from the topic of assisting others with coping and treating illness.

Thus, a heretofore unaddressed need exists in the industry to address the aforementioned deficiencies and inadequacies.

### SUMMARY OF THE INVENTION

In light of the forgoing, the preferred embodiment of the present invention generally relates to a system and method for providing a video support group to medical patients to assist in the treatment of medical conditions.

Generally, the system utilizes a user terminal that provides voice, sound and data capabilities to medical patients. A caregiver is provided with medical records and personal information of each individual within a group of patients having the same, or similar illness. The caregiver schedules a specific time for a live video conference that all selected patients are invited to attend via their terminals. The live video conference addresses the symptoms and progression of the illness shared by individuals within the group, and treatment of the illness, as well as mental anguish and personal experiences. The terminals are also used to ensure that the patient is performing proper treatment methods in addressing the illness in accordance with prescribed medical care.

The present invention can also be viewed as providing a method for providing a remedial video support group to medical patients. In this regard, the method can be broadly summarized by the following steps: selecting a caregiver to assist in the treatment of at least one patient; the caregiver examining the medical records of the patient; the caregiver scheduling a video conference with the patient based upon examination of the medical records, wherein the caregiver communicates with the patient via a caregiver terminal, located local to the caregiver, and a patient terminal, located local to the patient, the frequency of the scheduling being based upon a medical condition of the patient described within the medical records; and, providing a video conference between the caregiver and the patient wherein the medical condition of the patient is discussed in accordance with the medical records.

The invention has numerous advantages, a few of which are delineated hereafter as examples. Note that the embodiments of the invention, which are described herein, possess one or more, but not necessarily all, of the advantages set out hereafter.

One advantage of the invention is that it provides a means for a patient to communicate with other individuals afflicted with a common illness, without requiring the patient to move to a remote site for attendance of a support group.

Another advantage is that attendance to the video support group is monitored by a qualified group leader, thereby assuring that the patient attends the video support group and that the group deals with actual facts, rather than assumed facts, regarding their illness.

Another advantage is that the invention provides a method for ensuring that a patient is performing proper treatment methods in addressing an illness in accordance with prescribed medical care.

Other features and advantages of the present invention will be or become apparent to one with skill in the art upon examination of the following drawings and detailed description. It is intended that all such additional features and advantages be included herein within the scope of the present invention, as defined by the accompanying claims.

### BRIEF DESCRIPTION OF THE DRAWINGS

The present invention will be more fully understood from the detailed description given below and from the accompanying drawings of the preferred embodiments of the invention, which, however, should not be taken to limit the invention to the specific embodiments, but are for explanation and better understanding. Furthermore, the drawings are not necessarily to scale, emphasis instead being placed upon clearly illustrating the principles of the present invention. Finally, like reference numerals in the figures designate corresponding parts throughout the several drawings.

FIG. 1 is a block diagram illustrating a typical Internet based system upon which the remedial system of the present invention may be implemented.

FIG. 2 is a block diagram that further illustrates a Web server illustrated by FIG. 1.

FIG. 3 is a flow chart that illustrates logic performed by the remedial system of FIG. 1 for the assignment of a patient to the remedial system.

FIG. 4 is a flow chart that illustrates logic performed by the remedial system of FIG. 1 for assigning and situating a caregiver to assist in the treatment of a patient.

### DETAILED DESCRIPTION OF THE PREFERRED EMBODIMENT

The remedial system of the present invention can be implemented in software, firmware, hardware, or a combination thereof. In the preferred embodiment of the invention, which is intended to be a non-limiting example, the system is implemented in software that is executed by a computer, for example, but not limited to, a personal computer, workstation, mini computer, or mainframe computer.

The software-based system, which comprises an ordered listing of executable instructions for implementing logical functions, can be embodied in any computer-readable medium for use by, or in connection with, an instruction execution system, apparatus, or device such as a computer-based system processor-containing system, or other system that can fetch the instructions from the instruction execution system, apparatus, or device and execute the instructions. In the context of this document, a “computer-readable medium” can be any means that can contain, store, communicate, propagate or transport the program for use by or in connection with the instruction execution system, apparatus or device. The computer-readable medium can be, for example, but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disk read-only memory (CD ROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner, if necessary, and then stored in a computer memory.

Preferably, the remedial system of the present invention is implemented with use of the Internet. As such, a brief description and explanation of terms associated with the Internet follow. A browser, or “Web” browser, allows for simple graphical user interface (GUI) access to network servers, which support documents formatted as so-called Web pages. The World Wide Web (WWW), or “Web”, is a collection of servers on the Internet that utilize a Hypertext Transfer Protocol (HTTP), which is an application protocol that provides users access to files (which can be in different formats such as text, graphics, images, sound, video, etc.) using a Standard Generalized Markup Language (SGML), which is an information management standard for providing platform-independent and application-independent documents that retain formatting, indexing, and linking information. SGML provides a grammar-like mechanism for users to define the structure of their documents and the tags they will use to denote the structure in individual documents. The page description language known as Hypertext Markup Language (HTML) is an application of SGML. HTML provides basic document formatting of text and images and allows the developer to specify hyperlinks, or “links,” to other servers and files.

Use of an HTML-compliant client, such as a Web browser, involves specification of an address via a Uniform Resource Locator (URL). Upon such specification, the client makes a TCP/IP request to the server identified in the URL and receives a “Web page” (namely, a document formatted according to HTML) in return.

Electronic mail (e-mail) is another important part of online activity. Conventional e-mail is the exchange of text messages and computer files over a communications network, such as a local area network (LAN) or the Internet, usually between computers or terminals. Routing of email on the Internet is typically accomplished through the use of a protocol for sending messages called the simple mail transfer protocol (SMTP).

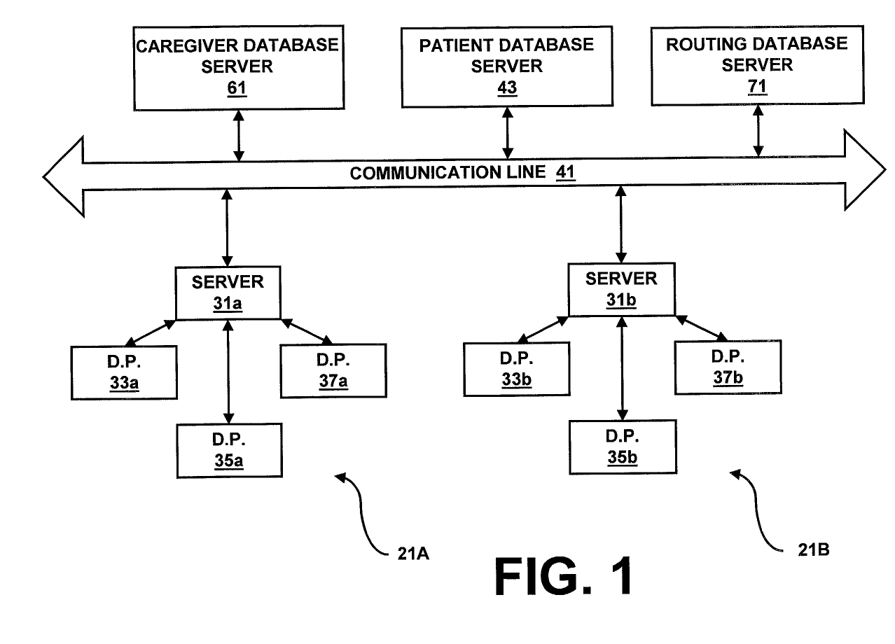

By way of example and illustration, FIG. 1 illustrates a typical Internet based system upon which the remedial system 100 of the present invention may be implemented. It should be noted that while the present disclosure provides implementation of the remedial system 100 within an Internet based system, the remedial system 100 need not be provided via use of the Internet. Instead, one of reasonable skill in the art will appreciate that the remedial system 100 may be implemented within other mediums, such as, for example, but not limited to, a local area network, or wide area network (WAN).

Further, in accordance with an alternative embodiment of the invention, the remedial system 100 may instead utilize a multi-point control unit (MCU), instead of a personal computer, wherein video conferencing systems located at several locations may be interconnected for conferencing between patients and a caregiver, as described hereinbelow. As known in the art, to initiate a conference using a MCU, a session host dials a number or makes some other appropriate connection, such as a TCP/IP link, and then presents a conference identifier. The MCU then automatically sets up the conference and establishes TCP/IP connections to each user. Alternatively, users at other locations may then join the conference by dialing an access number to the MCU for instantaneous connection.

Referring to FIG. 1, a plurality of networks 21a, 21b are shown wherein each network 21a, 21b includes multiple digital processors 33, 35, 37. Digital processors 33, 35, 37 within each network 21a, 21b may include, but are not limited to, personal computers, mini computers, laptops, workstations, and the like. The digital processors provide patients and caregivers with the ability to hear, speak, and see other patients or caregivers, as described hereinbelow. Each digital processor 33, 35, 37 is typically coupled to a host processor or server 31a, 31b for communication among processors 33, 35, 37 within the specific corresponding network 21a, 21b.

The host processor, or server, 31a, 31b is coupled to a communication line 41 that interconnects or links the networks 21a, 21b to each other, thereby forming an Internet. As such, each of the networks 21a, 21b are coupled along the communication line 41 to enable access from a digital processor 33a, 35a, 37a of one network 21a to a digital processor 33b, 35b, 37b of another network 21b.

Various end-user servers 43, 61, two of which are shown as an example, specifically, a patient database server 43 and a caregiver database server 61, are linked to the communication line 41, thus providing the patient and caregiver with access to the Internet. The caregiver database server 61 allows a caregiver to interact with patients via the Internet, as further explained hereinbelow. Likewise, the patient database server 43 allows a patient to interact with the remedial system 100 via the Internet.

In accordance with the preferred embodiment of the invention, the software for implementation of the remedial system 100 is provided by a software program stored within the patient database server 43 and the caregiver database server 61, that is operated on and connected to the Internet, for communication among the various networks 21a, 21b and/or digital processors 33, 35, 37 and other end-users connected to the Internet. In accordance with the preferred embodiment of the invention, the patient database server 43 and the caregiver database server 61 may run any form of operating system, such as, but not limited to, Microsoft Windows, to support operation of the present remedial system 100. Preferably, the networks 21a, 21b used by the remedial system 100 are secure and encrypted for purposes of ensuring the confidentiality of information transmitted within and between the networks 21a, 21b.

A routing database server 71 is also connected to the Internet via the communication line 41. In accordance with the preferred embodiment of the invention, the routing database server 71 is capable of storing patient data, such as, but not limited to, medical records. It should be noted that the routing database server 71 may be located within either the caregiver database server 61, the patient database server 43, or in any other location.

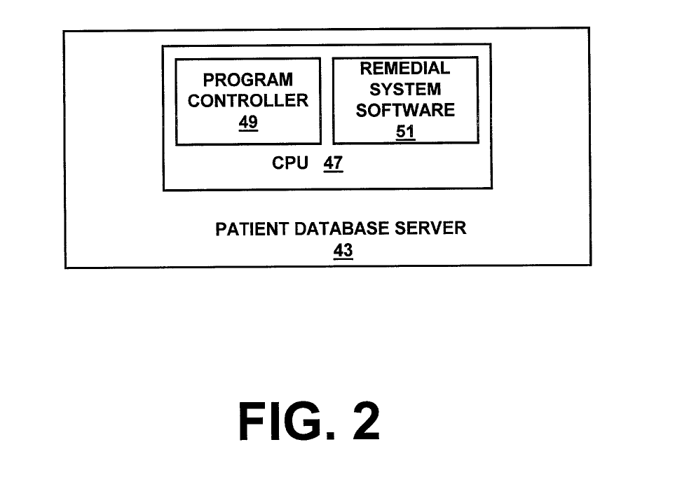

FIG. 2 is a block diagram that further illustrates the patient digital processor 45 of FIG. 1. As shown by FIG. 2, the patient digital processor 45 comprises a central processing unit (CPU) 47 having a program controller 49 and the remedial system software 51. The program controller 49 is capable of performing functionality required by the remedial system 100, as described in detail hereinbelow. Locating and updating data within the routing database server 71, as required by the remedial system 100, is performed by the program controller 49. It should be known that the program controller 49 and remedial system software 51 may instead be located within a memory (not shown) which is connected to the CPU 47.

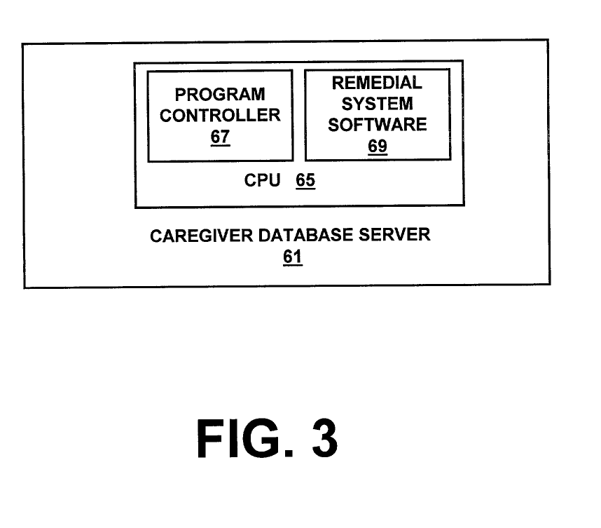

FIG. 3 is a block diagram that further illustrates the caregiver database server 61 of FIG. 1. As shown by FIG. 3, the caregiver database server 61 comprises a CPU 65 having a program controller 67 and the remedial system software 69. The program controller 67 is capable of performing functionality required by the remedial system 100, as described in detail herein below. The locating and updating of data within the caregiver database server 61, as required by the remedial system 100, is performed by the program controller 67.

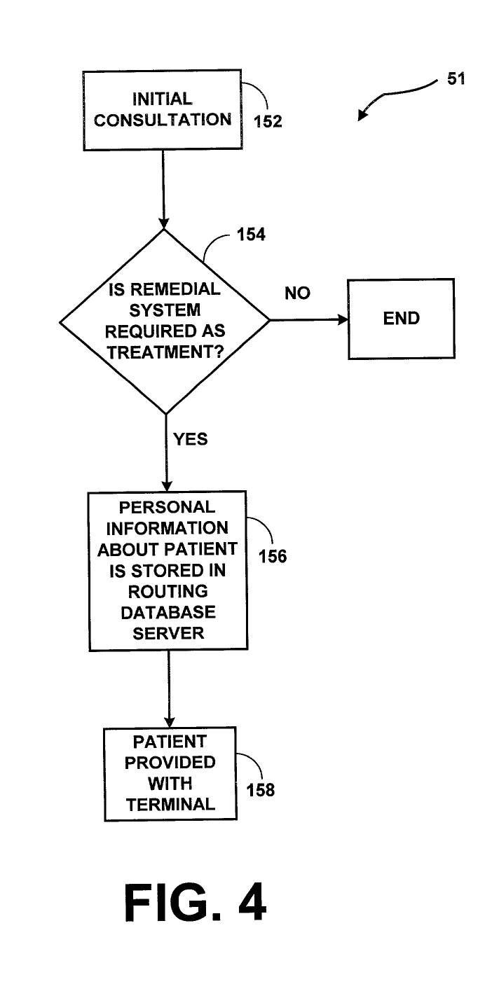

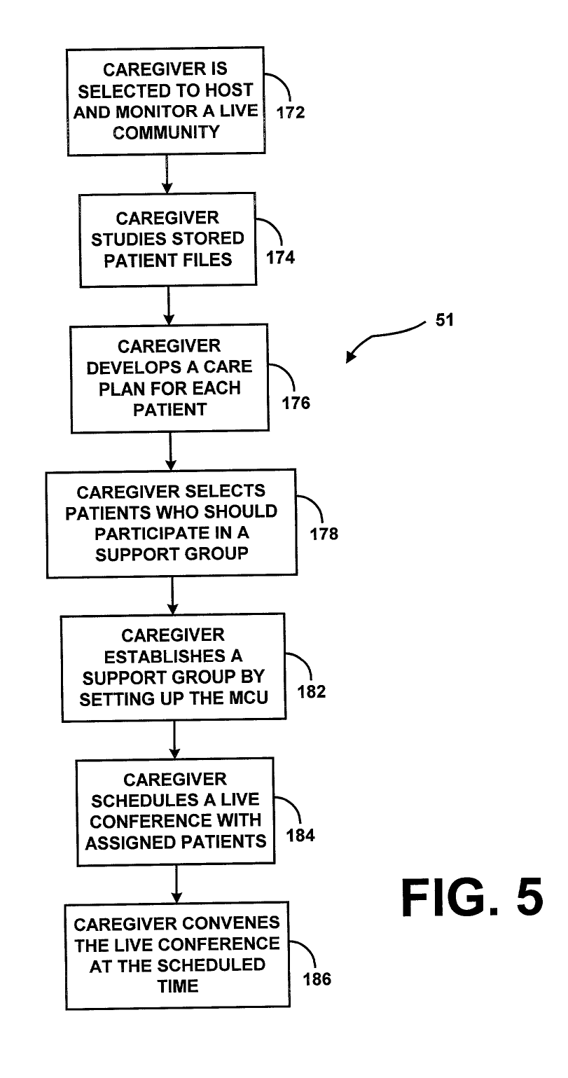

FIG. 4 is a flow chart that illustrates logic performed by the remedial system 100 for the assignment of a patient to a remedial system 100. With regard to all flow charts described herein, each block represents a module, segment, or portion of code, which comprises one or more executable instructions for implementing the specified logical function(s). It should also be noted that in some alternate implementations, the functions noted in the blocks may occur out of the order noted. For example, two blocks shown in succession may in fact be executed substantially concurrently, or the blocks may sometimes be executed in the reverse order, depending upon the functionality involved.

As shown by block 152, an initial consultation, or a series of consultations, takes place between a caregiver and a patient having an illness. Based upon the patient's illness and actions during the initial consultations, use of the present remedial system 100 may be required as part of the treatment for the illness (block 154). Preferably, the present remedial system 100 is made available to patients that require monitoring as part of treatment for the illness with which they 20 have been diagnosed. Signs of a patient that may require monitoring during medical treatment may include, but are not limited to, having an illness which decreases responsiveness and consciousness with stage advancement of the illness, deep depression, lack of compliance with diet, medication and exercise regimens, and social isolation.

As shown by block 156, when a patient has been recommended for use of the present remedial system 100, personal information about the patient, including information about the progression of the addressed illness, is stored in the routing database server 71. Preferably, this information includes, but is not limited to, the patient's age, blood type, illness diagnosis, address, vital signs history, treatment notes, and supporting caregivers assigned to that patient. This information may later be reviewed by a caregiver assigned to work with the patient, as described hereinbelow.

As shown by block 158, the patient is then provided with a personal computer, workstation, mini computer, laptop, or mainframe computer (hereinafter referred to as a terminal) that is programmed to be used in accordance with the present remedial system 100. It is important that the patient digital processor 45 provide video and speech capability to the patient in a conference environment. It is also valuable, but not necessary, to provide data handling capabilities.

FIG. 5 is a flow chart that illustrates logic performed by the present remedial system 100 for assigning and situating a caregiver to assist in the treatment of a patient. In accordance with the preferred embodiment of the invention, a caregiver is selected to host and monitor a live community that comprises a group of patients who have been diagnosed with the same, or similar illness (block 172). Preferably, the caregiver has extensive knowledge regarding the illness confronted by the patients in the live community. As shown by block 174, when assigned to a specific group of medical patients who are to use the remedial system 100, the caregiver studies the patient's files which have been previously stored within the routing database server 71.

The caregiver then develops a care plan for each patient within their assigned group of medical patients (block 176). As shown by block 178, the caregiver then selects patients who should participate in a support group based upon their observation, as described above with reference to FIG. 4. Next, the caregiver establishes the support group by, for example, setting up the MCU, the method of which is known in the art (block 182). The caregiver then schedules a live conference with the patients assigned to him/her via the live community, wherein all patients may interact via voice, sound and/or data (block 184). Finally, the caregiver convenes the live conference at the scheduled time (block 186).

The scheduling of live conferences with the patients assigned to a caregiver may be performed in numerous ways to ensure regular monitoring of patients. The frequency of scheduled live conferences is directly related to the type of illness confronted by the patients assigned to the caregiver. As an example, if the patients were afflicted with pneumonia they would most likely be required to attend a scheduled live conference daily to ensure progress in the treatment of the illness. Alternatively, if patients were afflicted with cancer, the scheduled live conference might meet one a week or biweekly due to slow progression of the illness.

The frequency of scheduled live conferences may also be determined by mental anguish associated with a patient learning that they are afflicted with an illness or by the lack of supporting family members in the home. As an example, if a caregiver obtains a group of patients that have recently learned of affliction with a terminal illness, such as, but not limited to, Acquired Immune Deficiency Syndrome (AIDS), the caregiver may schedule live conferences numerous times in a single day. In this situation, the severity of the illness and associated personal and social hardships, such as loss of friends, family, job, and basic discrimination, warrants the frequency of required live conferences as a means to vent concerns and newly encountered difficulties. In this fashion, the remedial system 100 not only serves as a method of monitoring the progression of treatments and stages of an illness, but also as a means for allowing a patient to voice personal concerns and experiences to other patients and a caregiver, thereby assisting in the relief of depression and anxiety.

It should be noted that the live community is preferably kept in an ongoing monitoring program by the caregiver. As such, the remedial system 100 provides for continued medical analysis and patient safety. In fact, the remedial system 100 may even be used to ensure that proper actions are being taken by a patient to improve their medical condition. As an example, if the health of a patient having bronchitis has not improved after a long period of time, a caregiver may become suspicious as to whether the patient understands the importance of taking their prescription on a regular basis.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

The following is claimed:

1. A system for providing a remedial video support group, comprising:
at least one patient terminal having video capabilities, wherein said patient terminal is controlled by a patient;
a caregiver terminal capable of communicating with said patient terminal via video, wherein said caregiver terminal is controlled by a caregiver; and
a routing database server capable of storing information regarding said patient, and information regarding said caregiver,
wherein said caregiver provides a video conference with said patient discussing a medical illness with which said patient has been afflicted.

2. The system of claim 1, wherein said system is provided via the Internet.

3. The system of claim 1, wherein said system is provided via an Intranet system.

4. The system of claim 1, wherein said patient terminal further comprises data and voice capabilities, thereby allowing said caregiver to transmit data and speak to said patient, via said caregiver terminal.

5. The system of claim 1, wherein said system comprises a series of patient terminals, each of which is controlled by a single patient, said patients having a similar illness, and wherein said patients are scheduled by said caregiver to video conference with said caregiver via said patient terminals and caregiver terminal, respectively.

6. A system of claim 1, wherein said caregiver has personal experience with reference to said medical illness.

7. The system of claim 1, wherein said patient terminal is located local to said patient, such that it is not necessary for said patient to move to a remote site in order to communicate with said caregiver.

8. The system of claim 1, wherein said information regarding said patient stored within said routing database is selected from the group consisting of illness progression, age, blood type, address, illness diagnosis, vital signs history and treatment notes.

9. The system of claim 1, wherein said patient terminal and said caregiver terminal are connected through multi-point control units.

10. A method of providing a remedial video support group, comprising the steps of:
selecting a caregiver to assist in the treatment of at least one patient;
said caregiver examining medical records of said patient;
said caregiver scheduling a video conference with said patient based upon examination of said medical records, wherein said caregiver communicates with said patient via a caregiver terminal, located local to said caregiver, and a patient terminal, located local to said patient, the frequency of said scheduling being based upon a medical condition of said patient described within said medical records; and
providing a video conference between said caregiver and said patient wherein said medical condition of said patient is discussed in accordance with said medical records.

11. The method of claim 10, further comprising the step of adjusting the frequency of said video conference in accordance with advancements in said medical condition of said patient.

12. The method of claim 10, further comprising the step of said caregiver selecting from a group of patients, which patients will partake in said video conference, based upon said examination of said medical records.

13. The method of claim 10, wherein said patient terminal and said caregiver terminal further comprises data and voice capabilities, thereby allowing a caregiver to transmit data and speak to a patient, via said caregiver terminal.

14. The method of claim 12, wherein said caregiver and said patients are capable of communicating simultaneously within said video conference such that all of said patients are capable of learning from the questions and answers of all of said patients.

15. A system for providing a remedial video support group, comprising:
at least one first means of communication having video capabilities, wherein said first means of communication is controlled by a patient;
a second means of communication, controlled by a caregiver, wherein said second means of communication is capable of communicating with said first means of communication via video; and
a storage means capable of storing information regarding said patient, and information regarding said caregiver,
wherein said caregiver provides a video conference with said patient discussing a medical illness with which said patient has been inflicted.

16. The system of claim 15, wherein said system is provided via the Internet.

17. The system of claim 15, wherein said system is provided via an Intranet system.

18. The system of claim 15, wherein said first means of communication further comprises data and voice capabilities, thereby allowing said caregiver to transmit data and speak to said patient, via said second means of communication.

19. The system of claim 15, wherein said system comprises a series of first means of communication, each of which is controlled by a single patient, said patients having a similar illness, and wherein said patients are scheduled by said caregiver to video conference with said caregiver via said first means of communications and second means of communication, respectively.

20. The system of claim 15, wherein said first means of communication is located local to said patient, such that it is not necessary for said patient to move to a remote site in order to communicate with said caregiver.

21. The system of claim 15, wherein said information regarding said patient stored within said storage means is selected from the group consisting of illness progression, age, blood type, address, illness diagnosis, vital signs history and treatment notes.
